(19) United States
(12) Patent Application Publication
(10) Pub. No.: US 2013/0033748 A1
(43) Pub. Date: Feb. 7, 2013

(54) THREE-DIMENSIONAL DISPLAY SYSTEMS AND METHODS

(71) Applicants: Sagi Mathai, Palo Alto, CA (US); Huei Pei Kuo, Palo Alto, CA (US)

(72) Inventors: Sagi Mathai, Palo Alto, CA (US); Huei Pei Kuo, Palo Alto, CA (US)

(73) Assignee: HEWLETT-PACKARD DEVELOPMENT COMPANY, LP, Fort Collins, CO (US)

(21) Appl. No.: 13/641,397

(22) PCT Filed: Apr. 15, 2010
(86) PCT No.: PCT/US10/31152

§ 371 Date: Oct. 15, 2012

(51) Int. Cl. G02B 27/22

(52) U.S. Cl. 359/463; 359/462

(57) ABSTRACT

Various embodiments of the present invention are directed to three-dimensional displays. In one aspect, a display comprises a pixel array (104) and an optical element array (102) disposed in close proximity to the pixel array. The pixel array is operated to display two or more images. The optical element array is configured and operated to direct each image to an associated viewing position, enabling a viewer to separately view each image from the associated viewing position.

### TECHNICAL FIELD

Embodiments of the present invention relate to three-dimensional display technology and microlens technology.

### BACKGROUND

In recent years, the advent of stereo display technologies enabling viewers to view objects in three-dimensions with two-dimensional displays has been gaining interest and acceptance. With typical stereo display technology, viewers are required to wear eye glasses that control the visual content delivered to each eye. However, it is often the case that the relative orientations of the projections received by the viewer are correct only for certain viewing locations, such as locations where a viewer's view is orthogonal to the center of a display. By contrast, viewers watching the same display outside these viewing locations experience a re-projection error that manifests as a vertical misalignment of the visual content received by the eyes of the viewers. If the images are very different, then in some cases one image at a time may be seen, a phenomenon known as binocular rivalry. These kinds of visual artifacts can be distracting and are cumulative to most viewers, leading to eye strain, nausea, fatigue, and possibly rejection of the stereo display technology. Thus, mere below threshold objectionableness may not be sufficient for permitting the presence of such artifacts.

Designers and manufacturers of three-dimensional display systems continue to seek improvements in three-dimensional display technology.

### BRIEF DESCRIPTION OF THE DRAWINGS

FIGS. 1A-1B show an isometric view and an exploded isometric view, respectively, of an example three-dimensional display configured in accordance with one or more embodiments of the present invention.

FIG. 2 shows a second exploded isometric view of the display, shown in FIG. 1, configured in accordance with one or more embodiments of the present invention.

FIG. 3 shows an example of an optical element of an optical element array and an associated pixel of a pixel array arranged in accordance with one or more embodiments of the present invention.

FIG. 4A shows rotational axes associated with a convex circular lens and a rotational axis associated with a convex cylindrical lens in accordance with one or more embodiments of the present invention.

FIG. 4B shows a Cartesian coordinate system associated with rotating an optical element in accordance with one or more embodiments of the present invention.

FIG. 5 shows examples of an optical element rotated about a central axis in accordance with one or more embodiments of the present invention.

FIG. 6 shows an example isometric view of an optical element array translated in accordance with one or more embodiments of the present invention.

FIG. 7 shows translational directions associated with a convex circular lens and a translational direction associated with a cylindrical lens in accordance with one or more embodiments of the present invention.

FIG. 8 shows examples of an optical element translated in accordance with one or more embodiments of the present invention.

FIG. 9 shows a top plan view of a three-dimensional display operated to provide horizontal parallax in accordance with one or more embodiments of the present invention.

FIG. 10 shows a side view of a three-dimensional display operated to provide vertical parallax in accordance with one or more embodiments of the present invention.

FIG. 11 shows an isometric view of a three-dimensional display operated to provide horizontal and vertical parallax in accordance with one or more embodiments of the present invention.

FIG. 12 shows a top plan view of a three-dimensional display operated to provide three-dimensional images of different perspective views in accordance with one or more embodiments of the present invention.

FIG. 13 shows a flow diagram of a method for viewing images from different viewing positions in accordance with one or more embodiments of the present invention.

### DETAILED DESCRIPTION

Various embodiments of the present invention are directed to three-dimensional displays including a rear projection two-dimensional pixel array and an optical element array. The three-dimensional display enables a viewer to perceive parallax and view objects or a scene in three dimensions by changing viewing positions. For example, the display can be operated so that as the viewer moves from one viewing position to the next, the viewer sees a different perspective view of the objects or scene. In certain embodiments described below, each perspective view can he a two dimensional image of the objects or scene. In other embodiments, each perspective view can be displayed as a stereo image pair enabling a viewer to perceive each perspective view of the objects or scene as three dimensional.

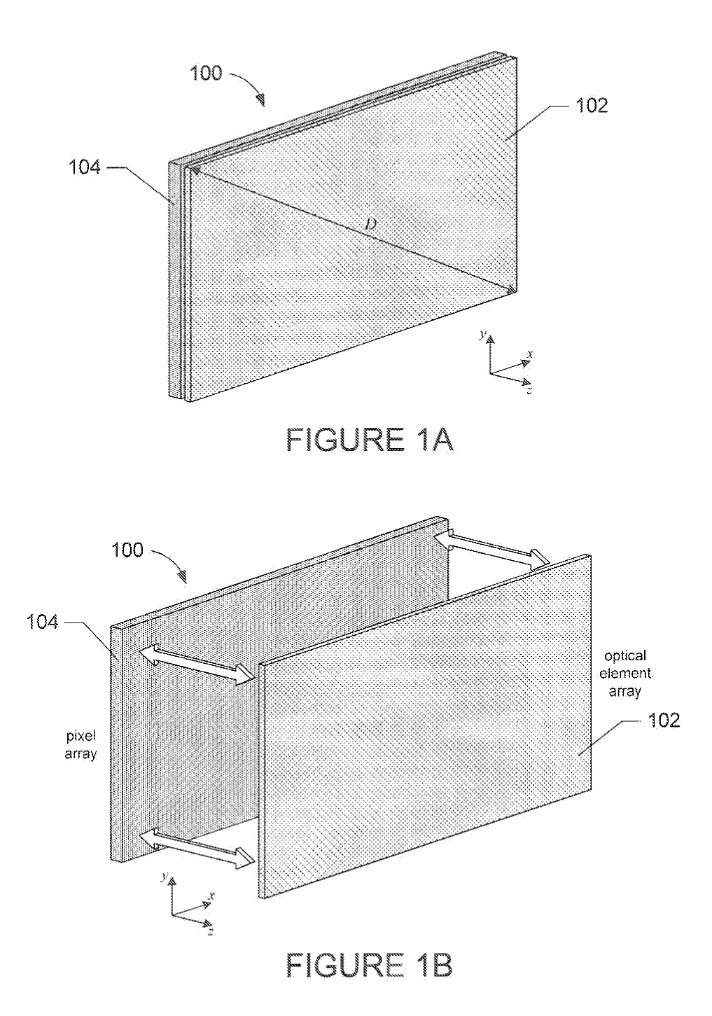

FIGS. 1A-1B show an isometric view and an exploded isometric view, respectively, of an example three-dimensional display 100 configured in accordance with one or more embodiments of the present invention. The display 100 includes a two-dimensional optical element array 102 in close proximity to a two-dimensional pixel array 104. The display 100 can be implemented in a variety of different kinds of electronic display devices, including cell phones, smart phones, monitors, and television sets. For example, the screen size, D, of the display 100 can range from about 6 cm, which is suitable for cell phones, smart phones and other handheld devices, up to about 115 cm or larger, which is suitable for a monitor or television.

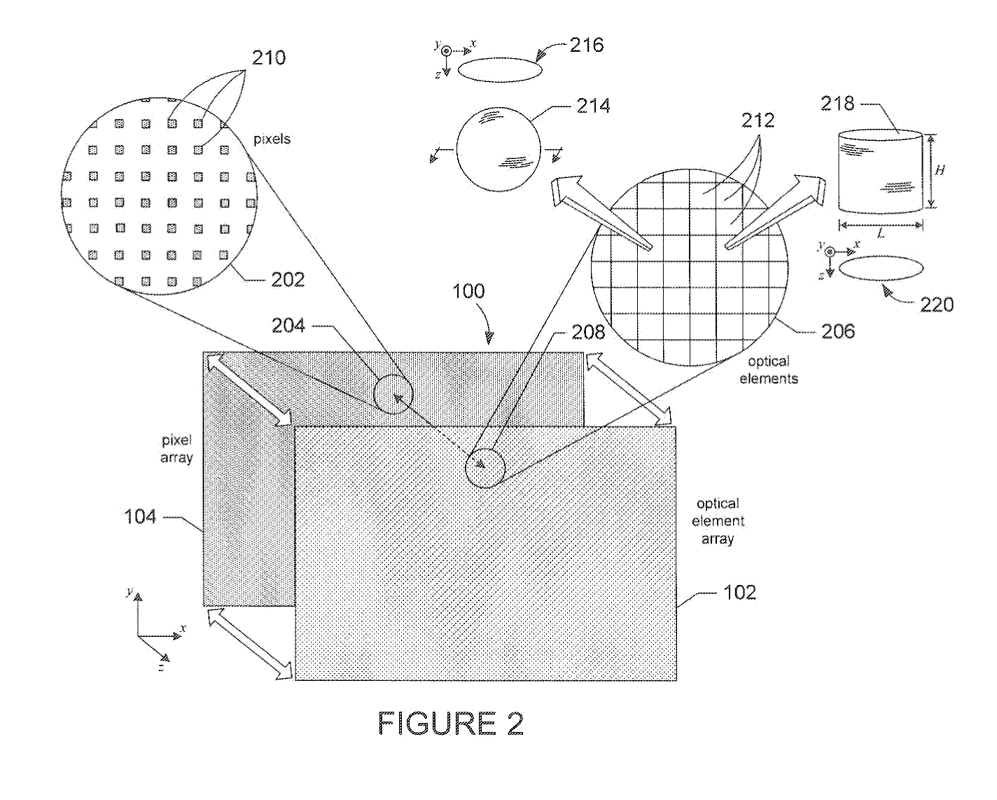

FIG. 2 shows a second exploded isometric view of the display 100 configured in accordance with one or more embodiments of the present invention. FIG. 2 includes an enlargement 202 of a portion 204 of the pixel array 104 and an enlargement 206 of a portion 208 of the optical element array 102. Enlargement 202 reveals a two-dimensional grid of pixels 210, and enlargement 206 reveals a two-dimensional grid of optical elements represented by adjacent squares 212. Each pixel represents the smallest discrete element of an image displayed by the pixel array 104, in certain embodiments described below, the optical elements 212 can be convex circular lenses, as represented by convex circular lens 214. FIG. 2 includes a cross-sectional view 216 of the convex circular lens 214 along a line I-I. In other embodiments described below, the optical elements 212 can be convex cylindrical lenses, as represented by convex cylindrical lens 218. FIG. 2 also includes a top view 220 of the convex cylindrical lens 218. The diameter of a convex circular lens, or length and height of a convex cylindrical lens, ranges from about 150 μm to about 350 μm. Each optical element of the optical element array 102 corresponds to a pixel in the pixel array 104. In other words, each pixel 210 generates light that is transmitted through a corresponding optical element 212.

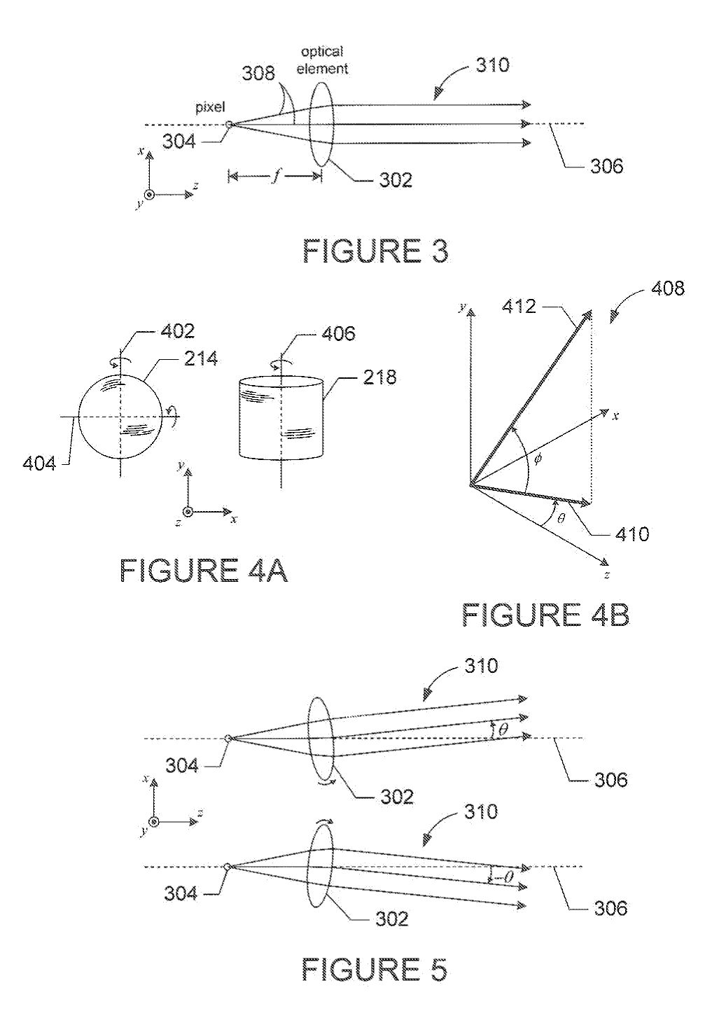

FIG. 3 shows an example of an optical element 302 of the optical element array 102 and an associated pixel 304 of the pixel array 104 arranged in accordance with one or more embodiments of the present invention. The pixel 304 and the optical element 302 are separated by the focal length, f, along a line 306 passing through the center of the optical element 302 and the center of the pixel 304. The optical element 302 can be a convex circular lens, such as the convex circular lens 214, or the optical element 302 can be a convex cylindrical lens, such as the convex cylindrical lens 218 viewed in the y-direction. Diverging rays 308 represent light emanating from the pixel 304 and passing through the optical element 302. As shown in the example of FIG. 3, when the optical element 302 is positioned parallel to the xy-plane of the optical element array 104, the convex shape of the optical element directs the light transmitted through the optical element 302 into a beam 310 that exits the optical element 302 and travels parallel to the line 306.

Each optical element 302 and associated pixel 304 forms a light field pixel. The optical elements of the optical element array can be rotated or translated in unison to control the direction in which the light field of an image displayed on the pixel array is projected.

Consider first rotating each of the optical elements to control the direction in which the image is projected. The optical element array can be configured with actuators coupled to each optical element so that each optical element can be separately rotated. FIG. 4A shows rotational axes 402 and 404 associated with the circular lens 214 and a single rotational axis 406 associated with the cylindrical lens 218. Because lens 218 has only a single axis of rotation 406, operation of the lens 218 is restricted to directing the beam of light emanating from an associated pixel to within the xz-plane. On the other hand, because lens 214 has two perpendicular axes of rotation, the lens 214 can be rotated to direct the beam of light emanating from an associated pixel in three dimensions. FIG. 4B shows a Cartesian coordinate system 408 with axes x, y, and z with the origin corresponding to the center of an optical element (not shown). The optical element can be either circular lens 214 or cylindrical lens 218 located at the origin of the coordinate system 408. Vector 410 represents the direction a beam of light transmitted through the lenses 214 and 218 travels in the xz-plane when the lenses 214 and 218 are rotated by the angle θ about the axes 402 and 406, respectively. FIG. 5 shows examples of the optical element 302 rotated by the angle +θ and the angle −θ about a central axis extending parallel to the y-direction. When the optical element 302 is rotated by +θ the transmitted beam 310 propagates with the angle +θ from the line 306, and when the optical element 302 is rotated by −θ, the transmitted beam 310 propagates with the angle −θ from the line 306. Note that the cylindrical lens 218 is not limited to the axis of rotation 406 being oriented in the y-direction. As described below, in certain optical element array 102 embodiments, the axis of rotation of the cylindrical lenses can be oriented in the x-direction, or any other suitable direction for directing the path of the beam 310. Returning to FIG. 4B, vector 412 represents the direction a beam of light transmitted through the lenses 214 travels when the lens 214 is rotated about the axis 402 by the angle θ and is rotated about the axis 404 by the angle φ.

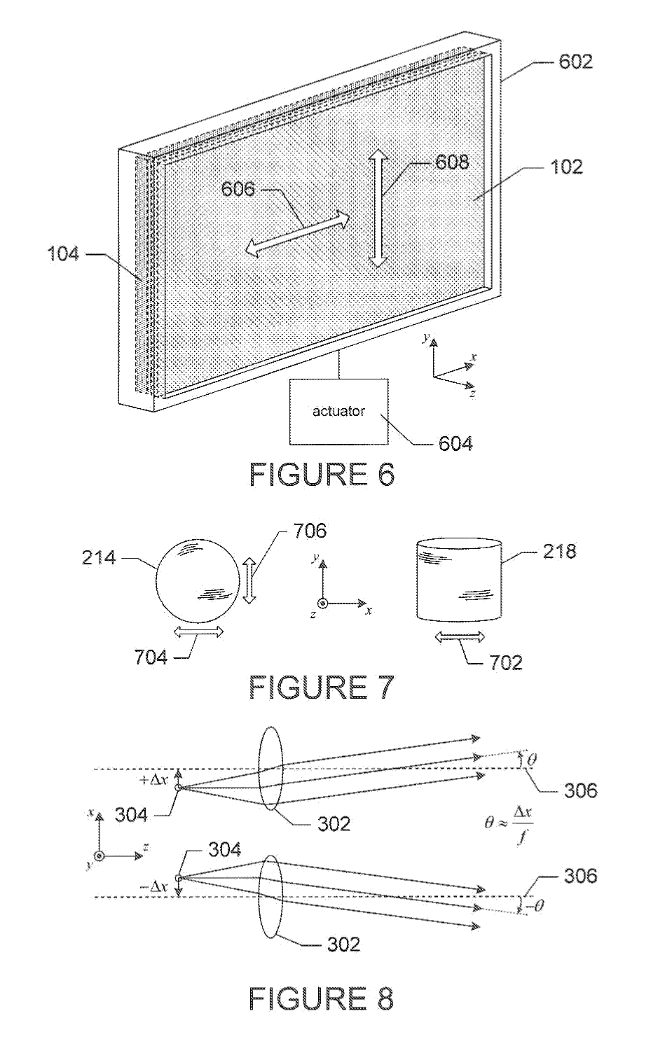

Now consider translating the optical elements of an optical element array in order to control the direction in which the image generated by the pixel array is projected. In certain embodiments, each element can be coupled to an actuator that translates the optical element in one or more directions. In other embodiments, various subgroups of optical elements can be translated within the optical element array. In still other embodiments, the entire optical element array can be translated. FIG. 6 shows an example isometric view of the optical element array 102 translated in the xy-plane in accordance with one or more embodiments of the present invention. As shown in the example of FIG. 6, the optical element array 102. and the pixel array 104 are disposed within a frame 602. The frame 602 is coupled to actuator 604 and configured to translate the optical element array 102 within the xy-plane, as indicated by directional arrows 606 and 608.

FIG. 7 shows translational directions associated with the circular lens 214 and a single translational direction associated with the cylindrical lens 218. Because lens 218 is convex in the x-direction, the lens 218 is translated only in the x-direction 702 and the beam of light emanating from the lens 218 lies within the xz-plane. FIG. 8 shows examples of the optical element 302 translated by a distance +Δx and −Δx in the x-direction. When the optical element 302 is translated by +Δx, the transmitted beam 310 propagates with the angle +θ from the line 306, and when the optical element 302 is translated by −Δx, the transmitted beam 310 propagates with the angle −θ from the line 306. Returning to FIG. 7, on the other hand, because lens 214 is convex symmetrical about the z-axis, the lens 214 can be translated in both the x- and y-directions 704 and 706 in order to direct the beam of light emanating from an associated pixel in three dimensions.

In other embodiments, the frame 602 is coupled to actuator 604 and configured to translate the pixel array 104 within the xy-plane, as indicated by directional arrows 606 and 608. In still other embodiments, the frame 602 is coupled to actuator 604 and configured to translate both the pixel array 104 and the optical element array 102 within the xy-plane, as indicated by directional arrows 606 and 608. In particular, when the pixel array 104 is translated in one direction the optical element array is translated in the opposite direction. For example, when the pixel array 104 is translated in the positive x-direction the optical element array 102 is in the negative x-direction. Translating both the pixel array 104 and the optical element array 102. reduces the switching speed by about ½ compared to exclusively translating either the pixel array 104 or the optical element array 102.

The display 100 can be configured and operated to present a viewer with different images shown by the display 102 from different viewing positions. The images can be of different scenes, or the images can be of different perspective views of the same objects or scene. For the sake of brevity, operation of the display 100 is now described for displaying different perspective views of objects or a scene that can be viewed from different viewing positions by rotating or translating individual optical elements or by translating the optical element array, although the same visual results can be obtained by translating the pixel array 104 alone of by translating both the pixel array 104 and the optical element array 102 in opposite directions The result is that the viewer perceives a three-dimensional image of the objects or scene by viewing the display 102 from the different viewing positions. The display 100 can be configured to provide horizontal (i.e., xz-plane), vertical (i.e., yz-plane), or horizontal and vertical parallax of objects or a scene. Parallax is the apparent displacement or difference in apparent position of objects as seen from different viewing positions.

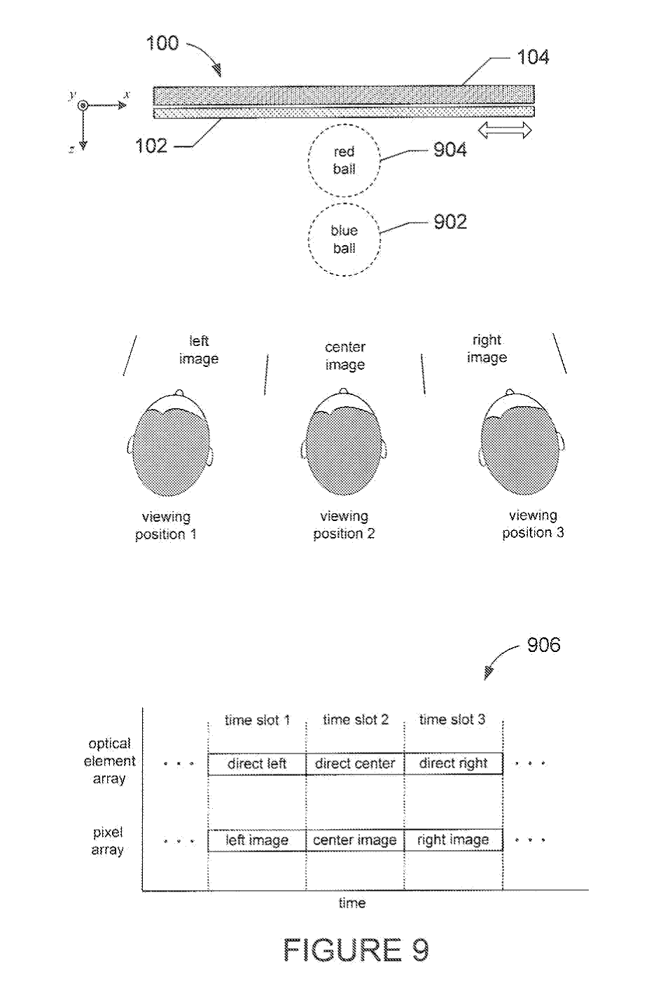

FIG. 9 shows a top plan view of the display 100 operated to provide horizontal perspective views in accordance with one or more embodiments of the present invention. In the example of FIG. 9, three different horizontal viewing positions are identified as viewing position 1, viewing position 2, and viewing position 3. The viewing positions have a range of associated viewing angles. A viewer looking at the display 100 from a particular viewing position sees one of the different horizontal perspective two-dimensional views of objects or a scene displayed by the display 100. The display of images of different horizontal perspective views are synchronized with rotating or translating the optical elements of the optical element display 102. Synchronizing images of different perspective views with the position of the optical elements can be accomplished using time-division multiplexing.

Consider, for example, displaying a scene composed of three different two-dimensional, horizontal, perspective views of the same two objects: a blue ball 902 positioned in front of a red ball 904, the blue ball and the red ball having the same diameter. Each horizontal perspective view image is displayed within a separate and approximately equal duration time slot. The horizontal perspective views are described using the terms “left” and “right,” which refer to left and right sides of a viewer facing the display 100. FIG. 9 includes a plot 906 of three time slots, each time slot corresponding to synchronized operation of the pixel array 104 and the optical element array 102. In time slot 1, the pixel array 104 displays a left perspective view, identified as “left image,” of the balls 902 and 904 so that a viewer looking at the display 100 from viewing position 1 sees the red ball 904 located behind and to the left of blue ball 902. In time slot 2, the pixel array 104 displays a center perspective view, identified as “center image,” of the balls 902 and 904 so that a viewer looking at the display 100 from viewing position 2 sees the blue ball 904 blocking the view of the red ball 904. In time slot 3, the pixel array 104 displays a right perspective view, identified as “right image,” of the balls 902 and 904 so that a viewer looking at the display 100 from viewing position 3 sees the red ball 904 located behind and to the right of the blue ball 904.

In order to direct each image to a corresponding viewing position, at the beginning of each time slot the optical elements are repositioned. At the beginning of time slot 1, the optical elements are repositioned to direct the left image toward viewing position 1; at the beginning of time slot 2, the optical elements are repositioned as described above with reference to FIG. 3 to direct the center image toward viewing position 2; and at the beginning of time slot 3, the optical elements are repositioned to direct the right image toward viewing position 3. In certain embodiments, when the optical element array 102 is configured with rotatable optical elements, the optical elements are repositioned by simultaneously rotating all of the optical elements parallel to the y-direction with the same angle of rotation, as described above with reference to FIGS. 4-5, Alternatively, in other embodiments, when the optical element array 102 is configured with translatable optical elements, the optical element array 102 is translated, or the individual optical elements are translated, in the x-direction, as described above with reference to FIGS. 6-8.

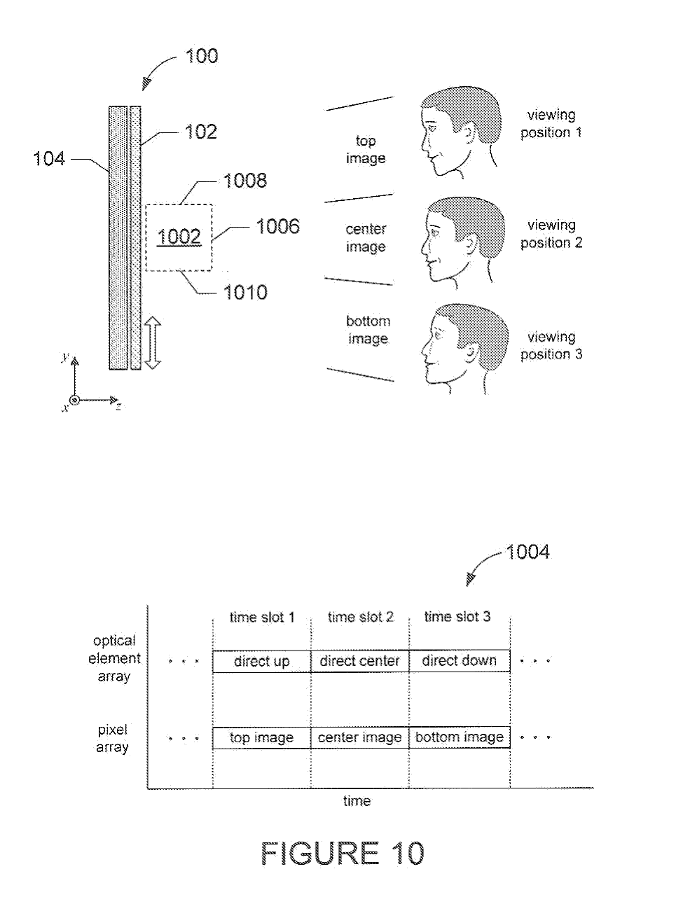

FIG. 10 shows a side view of the display 100 operated to provide vertical perspective views in accordance with one or more embodiments of the present invention. In the example of FIG. 10, three different vertical viewing positions are identified as viewing position 1, viewing position 2, and viewing position 3. The viewing positions have a range of viewing angles. A viewer looking at the display 100 from a particular viewing position sees one of the different vertical, perspective, two-dimensional views of objects or a scene displayed by the display 100.

Consider, for example, displaying a scene composed of three different two-dimensional, vertical, perspective views of a cube 1002. Each image of a perspective view is displayed within a separate and approximately equal duration time slot. FIG. 10 includes a plot 1004 of three time slots, each time slot corresponding to synchronized operation of the pixel array 104 and the optical element array 102. In time slot 1, the pixel array 104 displays a top perspective view, identified as “top image,” so that a viewer looking at the display 100 in viewing position 1 sees the front surface 1006 and top surface 1008 of the cube 1002. In time slot 2, the pixel array 104 displays a center perspective view, identified as “center image,” so that a viewer looking at the display 100 in viewing position 2 sees the front surface 1006 of the cube 1002. In time slot 3, the pixel array 104 displays a bottom perspective view, identified as “bottom image,” so that a viewer looking at the display 100 in viewing position 3 sees the front surface 1006 and a bottom surface 1010 of the cube 1002.

In order to direct each image to a corresponding viewing position, at the beginning of each time slot the optical elements are repositioned. At the beginning of each time slot, the optical elements are simultaneously rotated with the same angle of rotation or the optical element array 102 is translated, in order to direct each image to a corresponding viewing position. For example, at the beginning of time slot 1, the optical elements are positioned to direct the top image toward viewing position 1; at the beginning of time slot 2, the optical elements are positioned as described above with reference to FIG. 3 to direct the center image toward viewing position 2; and at the beginning of time slot 3, the optical elements are positioned to direct the bottom image toward viewing position 3. In certain embodiments, when the optical element array 102 is configured with rotatable optical elements, the optical elements are repositioned by simultaneously rotating all of the optical elements parallel to the x-direction with the same angle of rotation, as described above with reference to FIGS. 4-5. Alternatively, in other embodiments, when the optical element array 102 is configured with translatable optical elements, the optical element array 102 is translated, or the individual optical elements are translated, in the y-direction, as described above with reference to FIGS. 6-8.

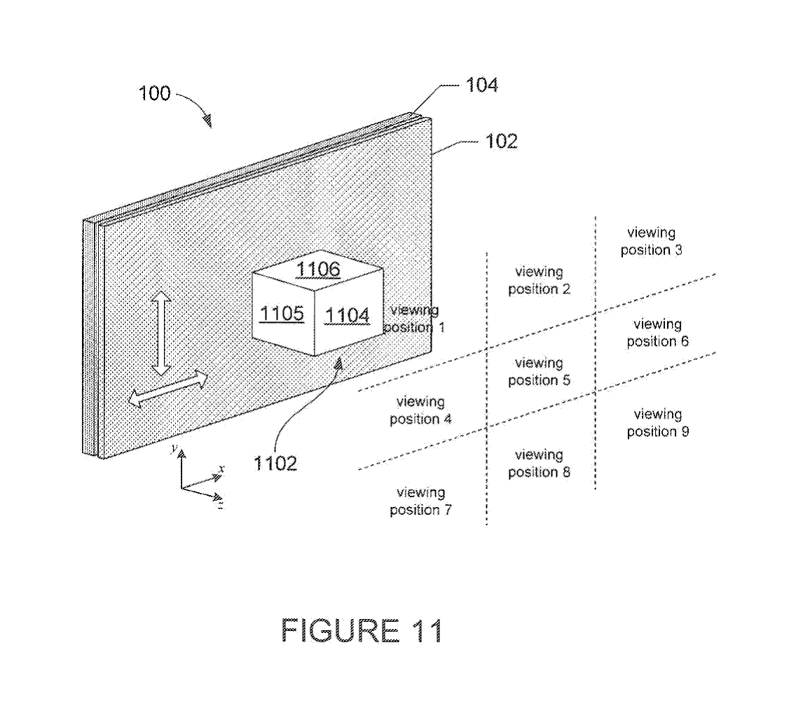

FIG. 11 shows an isometric view of the display 100 operated to provide horizontal and vertical perspective views in accordance with one or more embodiments of the present invention. In the example of FIG. 11, the display 100 is operated to display nine different perspective views of a cube 1102 with each is perspective view displayed in a separate time slot. In order to direct each perspective view to a corresponding viewing position, the optical elements of the optical element array are repositioned at the beginning of each time slot, in certain embodiments, the optical element array 102 is configured with circular lenses that can be rotated about the x- and y-axis, as described above with reference to FIGS. 4-5. In other embodiments, the optical element array 102 is configured with translatable optical elements, the optical element array 102 is translated, or the individual optical elements are translated, in the xy-plane, as described above with reference to FIGS. 6-8. The surfaces of the cube 1102 are displayed in different time slots and can be viewed by the looking at the display 100 from different associated viewing positions. For example, in one time slat, the pixel array 104 displays an image of the front, left side and top surfaces 1104-1106 of the cube 1102 that can be viewed by looking at the display 100 from viewing position 1. At the beginning of the same time slot, the optical elements are repositioned to direct the images of the front, left side and top surfaces 1104-1106 of the cube 1102 toward viewing position 1.

Note that in order for a viewer positioned at any one viewing positions to perceive a continuous image without image flicker due to switching between different images displayed for different viewing positions, the operations performed in each time slot are repeated with a frequency greater than 60 Hz.

A viewer is able to perceive parallax and perceive the objects or scene displayed in three dimensions by changing viewing positions. For example, returning to FIG. 9, a viewer initially located at viewing position 1 sees the red ball 904 located to the left and behind of the blue ball 902. As the viewer moves to viewing position 2, the viewer sees only the blue ball 902 blocking the view of the red ball 904. When the viewer moves to viewing position 3, the viewer sees the blue ball 902. located in front of and to the left of the red ball 904. As a result of viewing the display 100 from different viewing positions, a viewer is able to perceive the objects or scene displayed in three dimensions.

Note that operation of the display embodiments described above are not limited to the showing different perspective views of the same objects or a scene. The displays can also be used to display different images for each of the different viewing positions.

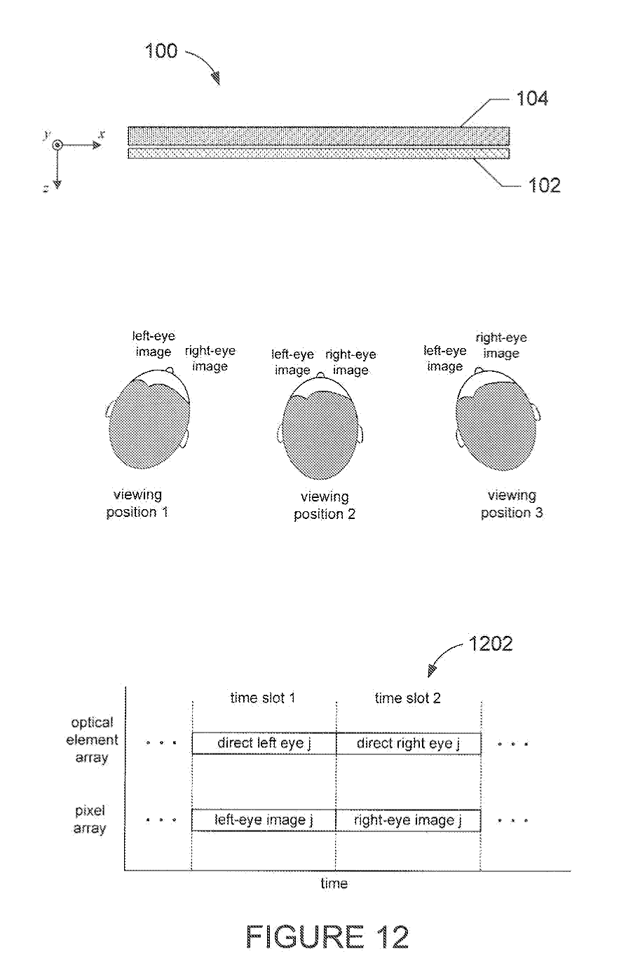

In other embodiments, the display can be operated to present a viewer with one or more three-dimensional images of different perspective views of objects or a scene from each viewing position. FIG. 12 shows a top plan view of the display 100 operated to provide three-dimensional images of different perspective views accordance with one or more embodiments of the present invention. The display 100 is operated to present a viewer looking at the display 100 from a particular viewing position with stereo left-eye and right-eye image pairs. For example, the display 100 is operated to present a viewer looking at the display 100 from viewing position 3 with a stereo image pair that corresponds to viewing in three dimensions the objects or scene displayed from a right perspective view. In other words, when a viewer is looking at the display 100 from viewing position 3, the display 100 is operated to direct a left-eye image of the stereo image pair to the viewer's left eye and direct a right-eye image of the stereo image pair to the viewer's right eye. The right-eye and left-eye images of each stereo image pair are displayed within separate and approximately equal duration time slots. FIG. 12 includes a plot 1202 of two times slots, each time slot corresponding to synchronized operation of the pixel array 104 and the optical element array 102. The index j corresponds to the different viewing positions 1, 2, and 3. In time slot 1, the pixel array 104 displays the left-eye in of a stereo image pair associated with looking at the display 100 from viewing position j. At the beginning of time slot 1, the optical element array 102 directs the left-eye image toward the left-eye position of the viewer located at viewing position j. In time slot 2, the pixel array 104 displays the right-eye image of a stereo image pair associated with looking at the display from viewing position j. At the beginning of time slot 2, the optical element array 102 directs the right-eye image toward the right-eye position of the viewer located at viewing position j. The operations of time slots 1 and 2 are repeated for each viewing position, and in order to present the viewer with a stereo image pair without flicker, the operations performed in each time slot are repeated with a frequency greater than 60 Hz.

Embodiments of the present invention are not limited to looking at three-dimensional images of different horizontal perspective views. In other embodiments, the pixel array 104 and the optical element array 102 can be configured and operated to provide three-dimensional images of different vertical perspective views, as described above with reference to FIG. 10, or different vertical and horizontal perspective views, as described above with reference to FIG. 11.

Methods for using the display 100 to display images that can be viewed from different viewing positions have been described above with reference to particular examples of displaying different perspective views of the same objects and scene. However, the display 100 is not so limited in its use. The display 100 can also be used to display entirely different images that can be viewed from different viewing positions.

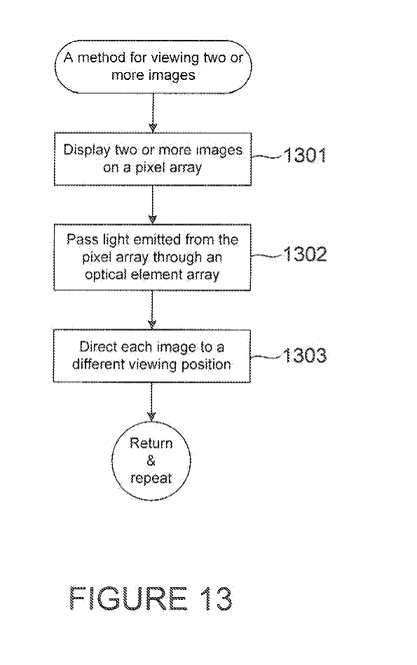

FIG. 13 shows a flow diagram of a method for viewing images from different viewing positions. in step 1301, two or more images are displayed on a pixel array, as described above with reference to FIGS. 9-12. Each image can be different or provide a different perspective view of object or scene. In certain embodiments, the images can be displayed in separate but approximately equal time slots using time-division multiplexing, as described above. In step 1302, the light emitted from each pixel of the pixel array is transmitted through a corresponding optical element of an optical element array, as described above with reference to FIG. 3, In step 1303, each image is directed to an associated viewing position, as described above with reference to FIGS. 9-12. A viewer looking at the display from each viewing position sees a different image.

The foregoing description, for purposes of explanation, used specific nomenclature to provide a thorough understanding of the invention. However, it will be apparent to one skilled in the art that the specific details are not required in order to practice the invention. The foregoing descriptions of specific embodiments of the present invention are presented for purposes of illustration and description. They are not intended to be exhaustive of or to limit the invention to the precise forms disclosed, Obviously, many modifications and variations are possible in view of the above teachings. The embodiments are shown and described in order to best explain the principles of the invention and its practical applications, to thereby enable others skilled in the art to best utilize the invention and various embodiments with various modifications as are suited to the particular use contemplated. It is intended that the scope of the invention be defined by the following claims and their equivalents:

1. A display comprising:
a pixel array (104); and
an optical element array (102) disposed in close proximity to the pixel array, wherein the pixel array is operated to display two or more images, and wherein the optical element array is configured and operated to direct each image to an associated viewing position enabling a viewer to separately view each image front the associated viewing position.

2. The display of claim 1, wherein the pixel array further comprises a two-dimensional array of pixels (210), and wherein the optical element array further comprises a two-dimensional array of optical elements (212).

3. The display of claim 2, wherein the pixel array and the optical element array are configured so that each pixel (304) emits light that is transmitted through a corresponding optical element (302) producing a beam of light.

4. The display of claim 3, wherein each optical element further comprises an actuator configured to rotate the optical element out of the plane of the optical element array about one or more axes of rotation to change the propagation direction of the beam of light.

5. The display of claim 3, wherein each optical element further comprises an actuator configured to translate the optical element within a plane of the optical element array to change the propagation direction of the beam of light.

6. The display of claim 3, wherein the optical elements further comprise an associated actuator configured to rotate subgroups of optical elements out of the plane of the optical element array to change the propagation direction of beams of light emanating from associated pixels of the pixel array.

7. The display of claim 3, wherein the optical elements further comprise an associated actuator configured to translate subgroups of optical elements within the plane of the optical element array to change the propagation direction of beams of light emanating from associated pixels of the pixel array.

8. The display of claim 2, wherein the optical elements further comprise convex circular lenses (214) or cylindrical lenses (218).

9. The display of claim 1, further comprising an actuator (604) configured to translate the optical element array within a plane of the optical element array.

10. The display of claim 1, further comprising one or more actuators configured to translate the pixel array and the optical element array in opposite directions within the plane of the display.

11. A method for viewing two or more images on a display comprising a pixel array and an optical element array, the method comprising:
displaying the two or more images on the pixel array (1301);
passing the light emitted from each pixel of the pixel array through an associated optical element of the optical element array (1302); and
directing each image to an associated viewing position by repositioning the optical elements (1303), enabling a viewer looking at the display to view each image from the associated viewing position.

12. The method of claim 11, wherein repositioning the optical elements further comprises rotating each optical element about one or more axis of rotation.

13. The method of claim 11, wherein repositioning the optical elements further comprises translating the optical elements within the plane of the optical element array.

14. The method of claim 11, wherein directing each image to an associated viewing position further comprising repositioning the pixel array.

15. The method of claim 9, wherein displaying two or more images further comprises displaying each of the two or more images within a separate time slot.
